(19) United States
(12) Patent Application Publication
(10) Pub. No.: US 2026/0192248 A1
(43) Pub. Date: Jul. 9, 2026

(54) COMPOSITE CATALYST FOR HYDROGEN SELECTIVE CATALYTIC REDUCTION, METHOD OF REMOVING NITROGEN OXIDES USING THE SAME, AND AIR PURIFICATION DEVICE INCLUDING COMPOSITE CATALYST

(71) Applicant: Samsung Electronics Co., Ltd., Suwon-si (KR)

(72) Inventors: Min Seok Koo, Suwon-si (KR); Hyukjae Kwon, Suwon-si (KR); Jaiyoung Chung, Suwon-si (KR); Jonghyun Ha, Suwon-si (KR); Dongjin Ham, Suwon-si (KR); Hyeonsu Heo, Suwon-si (KR); Seunghee Son, Suwon-si (KR); Sewon Jeon, Suwon-si (KR); Joungwoo Han, Suwon-si (KR); Iljeong Heo, Suwon-si (KR)

(21) Appl. No.: 19/411,473

(22) Filed: Dec. 8, 2025

(30) Foreign Application Priority Data
Jan. 8, 2025 (KR) 10-2025-0002880

(51) Int. Cl. B01D 53/86; B01J 21/06; B01J 23/652; B01J 35/64; B01J 37/00; B01J 37/08; B01J 37/34; F01N 3/20; F01N 3/28

(52) U.S. Cl. CPC B01D 53/8628; B01J 21/063; B01J 23/6522; B01J 23/6525; B01J 23/6527; B01J 35/647; B01J 35/651; B01J 37/0036; B01J 37/08; B01J 37/343; F01N 3/2066; F01N 3/2803; B01D 2251/202; B01D 2255/1021; B01D 2255/20776; B01D 2257/404; B01D 2258/06; F01N 2370/02

(57) ABSTRACT

A composite catalyst for hydrogen-selective catalytic reduction, a method of removing nitrogen oxides using the composite catalyst, and an air purification device including the composite catalyst. The composite catalyst is configured to remove a contaminant compound from an unpurified air stream containing the contaminant compound, and including a support and catalyst composite particles supported on the support, wherein the catalyst composite particles include platinum and a group 6 element oxide, and a content of the group 6 element oxide is about 0.1 parts by weight to about 5 parts by weight with respect to 1 part by weight of a content of the platinum.

### CROSS-REFERENCE TO RELATED APPLICATION

This application is based on and claims priority to Korean Patent Application No. 10-2025-0002880, filed on Jan. 8, 2025, in the Korean Intellectual Property Office, and all the benefits accruing therefrom under 35 U.S.C. § 119, the disclosure of which is incorporated by reference herein in its entirety.

### BACKGROUND

### 1. Field

The disclosure relates to a composite catalyst for hydrogen-selective catalytic reduction (H₂—SCR), a method of removing nitrogen oxides (NOx) using the composite catalyst, and an air purification device including the composite catalyst.

### 2. Description of the Related Art

Nitrogen oxides (NOx) are substances mainly generated from vehicle engines such as internal combustion engine, power plants using high temperatures, and steel mills. They are substances causing acid rain and ozone layer destruction, and are also substances producing fine dust through secondary reactions, so their removal is essential before atmosphere discharge. To date, selective catalytic reduction (SCR) using a post-treatment catalyst for reducing nitrogen oxides has been studied and commercialized.

When removing nitrogen oxides, selective non-catalytic reduction (SNCR) or selective catalytic reduction (SCR) methods using reducing agents such as ammonia and urea have been used. In the case of SNCR, a high temperature of about 950° C. to about 1150° C. is required as a reaction temperature, and in the case of NH₃—SCR using a catalyst, a temperature of about 350° C. to about 400° C. is generally required. Furthermore, unreacted NH₃ is legally regulated as an air pollutant, necessitating strict management. Therefore, a need remains for the develop catalysts that function under environmentally friendly and low-temperature conditions.

### SUMMARY

Provided is a composite catalyst for hydrogen-selective catalytic reduction (H₂—SCR), which provides improved harmful gas removal capability.

Provided a method of removing nitrogen oxides using the composite catalyst for H₂—SCR.

Provided is an air purification device including the composite catalyst for H₂—SCR.

Provided a method of preparing the composite catalyst for H₂—SCR.

Additional aspects will be set forth in part in the description which follows and, in part, will be apparent from the description, or may be learned by practice of the presented embodiments of the disclosure.

According to an aspect of the disclosure,
a composite catalyst for hydrogen-selective catalyst reduction (H₂—SCR) is configured to remove a contaminant compound from an air stream, e.g., an unpurified air stream, containing the contaminant compound, and includes
a support and
catalyst composite particles supported on the support,
wherein the catalyst composite particles include platinum and a group 6 element oxide, and
a content of the group 6 element oxide is about 0.1 parts by weight to about 5 parts by weight with respect to 1 part by weight of a content of the platinum.

The group 6 element oxide may include an oxide containing tungsten, chromium, molybdenum, or a combination thereof, for example, WOx (0<x≤3), Cr₂O₃, MoOx (0<x≤3), or a combination thereof.

According to another aspect of the disclosure, a method of removing nitrogen oxides (NOx) includes contacting an air stream including nitrogen oxides, e.g., a process gas, with a composite catalyst for H₂—SCR to remove the nitrogen oxides,
wherein the composite catalyst includes
a support and
catalyst composite particles supported on the support,
wherein the catalyst composite particles include platinum and a group 6 element oxide, and
a content of the group 6 element oxide is about 0.1 parts by weight to about 5 parts by weight with respect to 1 part by weight of a content of the platinum.

According to another aspect of the disclosure, an air purification device includes a housing, and a composite catalyst for H₂—SCR disposed within the housing,
wherein the composite catalyst for H₂—SCR is configured to remove a contaminant compound from an unpurified air stream containing the contaminant compound, and includes a support and catalyst composite particles supported on the support, wherein the catalyst composite particles include platinum and a group 6 element oxide, and a content of the group 6 element oxide is about 0.1 parts by weight to about 5 parts by weight with respect to 1 part by weight of a content of the platinum.

The air purification device may have an operation temperature of about 70° C. to about 200° C., an oxygen content of about 5 volume percent (vol %) to about 20 vol % or about 10 vol % to about 20 vol %, a nitrogen content of about 80 vol % to about 95 vol %, and a relative humidity of about 40% to about 60%. In the air purification device, an injection amount of hydrogen (H₂) gas may be about 100 parts per million (ppm) to about 20,000 ppm based on a total weight of exhaust gas and hydrogen gas.

According to another aspect of the disclosure, a method of preparing a composite catalyst for H₂—SCR includes: introducing a platinum-containing salt and a group 6 element oxide as catalyst composite particle precursors on a support to prepare a support having the supported catalyst composite particle precursors, and
mixing the support having the supported catalyst composite particle precursors with a reducing agent, performing a first heat treatment to obtain a catalyst precursor, and performing a second heat treatment on the catalyst precursor,
wherein the composite catalyst is configured to remove a contaminant compound from an airstream, e.g., an unpurified air stream or process gas containing the contaminant compound, and includes a support and catalyst composite particles supported on the support, wherein the catalyst composite particles include platinum and a group 6 element oxide, and a content of the group 6 element oxide is about 0.1 parts by weight to about 5 parts by weight with respect to 1 part by weight of a content of the platinum.

The first heat treatment may be performed at, for example, about 110° C. to about 140° C. or about 120° C. to about 130° C. The second heat treatment may be performed at a temperature of, for example, about 300° C. to about 900° C., about 350° C. to about 800° C., about 400° C. to about 700° C., or about 400° C. to about 500° C.

A grinding process may be further performed prior to performing the second heat treatment of the catalyst precursor.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A to 1D show scanning electron microscopy (SEM) images of the composite catalyst prepared in Example 1 in SEM-energy dispersive spectroscopy (EDS) analysis;

FIG. 2 is a graph showing conversion rates (percent, %) versus temperature (Celsius, °) of the nitrogen oxide (NOx) in the air purification devices of Manufacturing Examples 1 to 3 and Comparative Manufacturing Example 1 using the composite catalysts of Examples 1 to 3 and Comparative Example 1;

FIG. 3 is a graph showing the nitrogen gas selectivity (N₂ selectivity) (percent, %) versus temperature (Celsius, °) in the air purification devices of Manufacturing Examples 1 to 3 and Comparative Manufacturing Example 1 using the composite catalysts of Examples 1 to 3 and Comparative Example 1;

FIG. 4 is a graph showing the N₂O concentrations (parts per million, ppm) versus temperature (Celsius, °) in the air purification devices of Manufacturing Examples 1 to 3 and Comparative Manufacturing Example 1 using the composite catalysts of Examples 1 to 3 and Comparative Example 1;

FIG. 5 is a schematic view of a catalytic filter according to an embodiment;

FIG. 6 is a front view of an inflow side of the catalytic filter of FIG. 5, through which unpurified air is introduced;

FIG. 7 is a front view of an outflow side of the catalytic filter of FIG. 5, through which purified air is discharged;

FIG. 8 is a cross-sectional view of the catalytic filter of FIG. 5, taken along line 4-4′ shown in FIG. 6; and

FIG. 9 is an enlarged cross-sectional view of a first portion A1 in FIG. 9.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

The present inventive concept, which will be more fully described hereinafter, may have various variations and various embodiments, and specific embodiments will be illustrated in the accompanied drawings and described in greater detail. However, the present inventive concept should not be construed as being limited to specific embodiments set forth herein. Rather, these embodiments are to be understood as encompassing all variations, equivalents, or alternatives included in the scope of the present inventive concept.

The terminology used hereinbelow is used for the purpose of describing particular embodiments only, and is not intended to limit the present inventive concept. As used herein, the singular forms are intended to include the plural forms as well, unless the context clearly indicates otherwise. As used herein, the terms “comprises” and/or “comprising,” or “includes” and/or “including” specify the presence of stated features, regions, integers, steps, operations, elements, components, ingredients, materials, or combinations thereof, but do not preclude the presence or addition of one or more other features, regions, integers, steps, operations, elements, components, ingredients, materials, or combinations thereof. As used herein, “/” may be interpreted as “and”, or as “or” depending on the context.

In the drawings, the thicknesses of layers and regions may be exaggerated for clarity of description. Like reference numerals denote like elements throughout the specification. Throughout the specification, when a component, such as a layer, a film, a region, or a plate, is described as being “above” or “on” another component, the component may be directly above the another component, or there may be yet another component therebetween. It will be understood that although the terms “first,” “second,” etc. may be used herein to describe various elements, these elements should not be limited by these terms. These terms are only used to distinguish one element from another element. In the present specification and the drawings, elements that serve substantially the same function are labeled with the same reference numeral and may not be discussed redundantly.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10%, ±5%, or ±3% of the stated value.

Unless otherwise defined, the term “size” of a particle may refer to “particle diameter” of the particle.

The term “particle diameter” of particles, as used herein, refers to an average diameter if the particles are spherical, and refers to an average major axis length if the particles are non-spherical. The particle diameter of particles may be measured using a particle size analyzer (PSA). The term “particle diameter” of particles, as used herein, refers to, for example, an average particle diameter. Average particle diameter may be, for example, a median particle diameter (D50). Median particle diameter (D50) may refer to a particle size corresponding to a cumulative volume of 50 vol % as counted from the smallest particle size in a particle size distribution measured by a laser diffraction method. Alternatively, “average particle diameter” may be measured by software or a manual from a scanning electron microscope (SEM) image or a transmission electron microscope (TEM) image.

The term “metal” as used herein refers to both metals and metalloids such as silicon and germanium, in an elemental or ionic state.

The term “length” and “thickness” as utilized herein refers to, for example, an average length and an average thickness, respectively. The length and thickness are measured utilizing software from a scanning electron microscope image.

In the case of H₂—SCR using H₂ as a reducing agent, reaction temperature is lower than that in the case of selective catalytic reduction (SCR) using ammonia as a reducing agent, so nitrogen oxides (NOx) can be removed with little energy, but there is an urgent need to develop a catalyst that can remove nitrogen oxides (NOx) in the general atmosphere outside of internal combustion engines.

Hereinafter, a composite catalyst for selective catalytic reduction (H₂—SCR), a method of preparing the composite catalyst, a method for removing nitrogen oxides using the composite catalyst, and an air purification device according to embodiments will be described in more detail.

In the present disclosure, the composite catalyst for H₂-selective catalytic reduction (H₂—SCR) refers to an SCR composite catalyst that reduces harmful gases by using hydrogen.

### Composite Catalyst for H₂—SCR

A composite catalyst for H₂—SCR according to an embodiment is configured to remove a contaminant compound from an unpurified air stream containing the contaminant compound, and includes:
a support; and
catalyst composite particles supported on the support,
wherein the catalyst composite particles include platinum and a group 6 element oxide, and
a content of the group 6 element oxide is about 0.1 parts by weight to about 5 parts by weight with respect to 1 part by weight of a content of the platinum.

The group 6 element oxide is an oxide containing a group 6 element, for example, an oxide containing tungsten (W), chromium (Cr), molybdenum (Mo), or a combination thereof.

The composite catalyst may be used to remove nitrogen oxides (NOx) from exhaust gas by using hydrogen as a reducing agent. For example, nitrogen oxides (NOₓ) may be converted to N₂.

In the composite catalyst according to an embodiment, the group 6 element oxide is contained in the catalyst composite particles supported on the support, thereby improving the production of nitrogen oxides (NOₓ) species adsorbed on the composite catalyst and H₂ activity and improving a H₂—SCR efficiency by promoting the production of NH₄⁺.

In the composite catalyst according to an embodiment, the content of the group 6 element oxide is about 0.1 parts by weight to about 5 parts by weight based on 1 part by weight of the content of platinum, and the composite catalyst exhibits higher activity than a catalyst containing platinum alone at a lower reaction temperature (for example, about 100° C. to about 125° C.). When the content of the group 6 element oxide is less than 0.1 parts by weight or more than 5 parts by weight per 1 part by weight of the content of the platinum element, the ability to remove harmful gases such as nitrogen oxides (NOx) deteriorates.

A mixing weight ratio of the platinum and the group 6 element oxide is about 1:0.1 to about 1:5, about 1:0.1 to about 1:4, about 1:0.1 to about 1:3, or about 1:0.1 to about 1:2.

According to another embodiment, the mixing weight ratio of the platinum and the group 6 element oxide is about 1:0.2 to about 1:2, about 1:0.3 to about 1:2, about 1:0.4 to about 1:2, or about 1:0.5 to about 1:2. When the mixing weight ratio of the platinum and the group 6 element oxide is within the above range, nitrogen oxide removal ability is improved.

The group 6 element oxide may be, for example, tungsten (W) oxide, chromium (Cr) oxide, molybdenum (Mo) oxide, or a combination thereof, and, specifically, may be WOx (0<x≤3), Cr₂O₃, MoOx (0<x≤3), or a combination thereof.

The catalyst composite particles of the composite catalyst may include platinum (Pt) and tungsten oxide. The composite catalyst may be tungsten metal-free, i.e. the composite catalyst may be free of elemental tungsten. It can be confirmed through X-ray photoelectron spectroscopy (XPS) analysis that the composite catalyst according to an embodiment contains a tungsten oxide and is in a tungsten metal-free state.

The catalyst composite particle of the composite catalyst according to an embodiment is a compound represented by Formula 1 below:

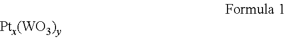

in Formula 1, 0.192≤x≤0.922, x+y=1.

When a H₂—SCR reaction is performed in the presence of oxygen using the composite catalyst for H₂—SCR according to an embodiment, a reaction represented by Reaction Formula 1 and/or Reaction Formula 2 below progresses, and thus nitrogen oxides (NOx) from exhaust gas are converted into N₂, N₂O and H₂O, thereby removing nitrogen oxides.

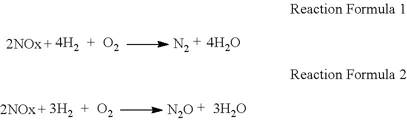

Here, x≥1.

The composite catalyst according to an embodiment includes a support and catalyst composite particles supported on the support and containing platinum and a group 6 element oxide, thereby improving the removal ability for various volatile organic compounds contained in unpurified air.

The support is silica (SiO₂), alumina (Al₂O₃), zeolite, titania (TiO₂), or a combination thereof.

According to an embodiment, the support is titania (TiO₂), specifically, anatase titania (TiO₂).

According to another embodiment, the support may be an aluminosilicate in an amorphous or crystalline state.

The support is an aluminosilicate, has a Si/Al ratio of 50 or less, 40 or less, about 10 to about 30, or about 22 to about 25, and has a mesoporosity (volume of mesopores) of about 20 vol % to about 80 vol %, about 30 vol % to about 80 vol %, about 40 vol % to about 80 vol %, about 50 vol % to about 80 vol %, or about 60 vol % to about 80 vol %. When the support has the above-described Si/Al ratio and mesoporosity, mass transfer becomes easier. Therefore, the removal of volatile organic compounds having an increased size becomes easier. The composite catalyst can further promote the decomposition reaction of volatile organic compounds by including the catalyst composite particles supported on the support. As a result, the composite catalyst can remove volatile organic compounds more effectively. For example, the rate of removal reactions of volatile organic compounds may increase. For example, the temperature at which nitrogen oxides, which are volatile organic compounds, are converted to nitrogen may be lowered. Therefore, the removal ability for various volatile organic compounds contained in unpurified air can be improved.

The composite catalyst according to an embodiment includes a support.

The size of the support may be, for example, about 0.5 micrometers (μm) to about 500 μm, about 0.5 μm to about 100 μm, about 0.5 μm to about 50 μm, about 0.5 μm to about 10 μm, or about 1 μm to about 5 μm. Since the support has a size within this range, the removal performance of the composite catalyst for volatile organic compounds can be further improved. The size of the support may be, for example, a diameter of the support as measured from a scanning electron microscope image or a transmission electron microscope image. The size of the support may be, for example, an average particle diameter. The average particle diameter may be measured by using, for example, a measurement device using a laser diffraction technique or a dynamic light scattering technique. The average particle diameter is measured using, for example, a laser scattering particle size distribution system (for example, LA-920, Horiba Inc.), and is a value of median particle size (D50) when 50% of the small particles are accumulated in volume conversion.

The support may include, for example, irregular particles, spherical particles having an aspect ratio of less than 2, non-spherical particles having an aspect ratio of 2 or more, or a combination thereof. The spherical particle may have an aspect ratio of, for example, 1.9 or less, 1.5 or less, or 1.2 or less. The spherical particle may have a sphericity of, for example, 0.85 or more, 0.9 or more, or 0.95 or more. The sphericity of the spherical particle may be calculated from, for example, Ψ=[π^{1/3}(6Vₚ)^{2/3}]Aₚ, wherein Ψ represents sphericity, Vₚ represents the volume of the particle, and Aₚ represents the surface area of the particle. The roundness of the spherical particle in a 2D projected image of the particle, may be, for example, 0.85 or more, 0.9 or more, or 0.95 or more. The roundness of the spherical particle may be calculated by C=[4πA]/P², wherein C represents roundness, A represents an area of the project, and P represents a perimeter of the project. The non-spherical particle may have an aspect ratio of, for example, 2 or more, 2.5 or more, or 3 or more. The aspect ratio of the non-spherical particle may be, for example, about 2 to about 100, about 2.5 to about 100, or about 3 to about 100. The sphericity of the non-spherical particle may be less than 0.8 The roundness of the non-spherical particle in a two-dimensional image may be less than 0.8. The non-spherical particles may include, for example, tube-shaped particles, plate-shaped particles, needle-shaped particles, rod-shaped particles, fibrous particles, or a combination thereof.

The composite catalyst may include a support, and the support may include SiO₂, Al₂O₃, zeolite, TiO₂, TiO₂, or a combination thereof. When using this support, various chemical reactions (for example, various oxidation reactions) for removing contaminants can be effectively performed.

The catalyst composite particles may be non-homogeneously supported on the support. The support may include an inner portion and an outer portion. The inner portion of the support may be defined, for example, by a second distance, which is a distance between a point corresponding to 80% of a first distance and the geometric center of the support, wherein the first distance is a distance between the geometric center of the support and a surface of the support. The outer portion of the support may be disposed on the inner portion of the support. The outer portion of the support may be defined by a third distance, which is a distance between a point corresponding to 80% of the first distance, e.g., the surface of the inner portion, and the surface of the support. The catalyst composite particles may be optionally supported on a portion of the support. All or part of the catalyst composite particles may be optionally disposed in the outer portion of the support. With the catalyst composite particles optionally disposed in the outer portion of the support, the composite catalyst may have a further improved rate of removal of volatile organic compounds. The content of catalyst composite particles disposed in the outer portion of the support may be higher than the content of catalyst composite particles disposed in the inner portion of the support. The ratio of the content of catalyst composite particles disposed in the outer portion of the support to the content of catalyst composite particles disposed in the inner portion of the support may be more than 100%, 110% or more, 120% or more, 150% or more, or 200% or more. The ratio of the content of catalyst composite particles disposed in the outer portion of the support to the content of catalyst composite particles disposed in the inner portion of the support may be more than 100% and not more than about 500%, about 110% to about 500%, about 120% to about 500%, about 150% to about 400%, or about 200% to about 300%. Since the content of catalyst composite particles disposed in the outer portion of the support is more than the content of catalyst composite particles disposed in the inner portion of the support, the composite catalyst may have a further improved rate of removal of volatile organic compounds.

The composite catalyst may further include B₂O₃. As a result, when the composite catalyst further includes B₂O₃, metal-support bonding may be better formed, and electron transfer may be easier.

The content of the B₂O₃ is about 0.5 parts by weight to about 2 parts by weight, about 0.8 parts by weight to about 2 parts by weight, or about 1 parts by weight to about 2 parts by weight based on 100 parts by weight of the support. When the content of B₂O₃ is within the above range, a composite catalyst having improved H₂—SCR activity may be prepared.

B₂O₃ may exist in the coating layer formed on the surface of the catalyst composite particle. When B₂O₃ exists in the coating layer, metal-support bonding may be better formed.

The size of the catalyst composite particle may be, for example, about 1 nanometers (nm) to about 300 nm, about 5 nm to about 200 nm, or about 10 nm to about 150 nm. In the composite catalyst according to an embodiment, the average particle size of platinum is about 1 nm to about 300 nm, about 5 nm to about 200 nm, or about 10 nm to about 150 nm, and the average particle size of the group 6 element oxide is about 1 nm to about 10 nm, about 2 nm to about 8 nm, or about 3 nm to about 7 nm. Since the catalyst composite particle, platinum and group 6 element oxide have sizes in these ranges, the effective contact area of the composite catalyst for volatile organic compounds may further increase. As a result, the removal performance of the composite catalyst for volatile organic compounds can be further improved. The size of the catalyst composite particle may be, for example, a diameter of the catalyst composite particle measured from a scanning electron microscope image or a transmission electron microscope image. The size of the catalyst composite particles may be, for example, an average particle diameter. The average particle diameter may be measured, for example, by using a measurement device using a laser diffraction technique or a dynamic light scattering technique. The average particle diameter is measured using, for example, a laser scattering particle size distribution system (for example, LA-920, Horiba Inc.), and is a value of median particle size (D50) when 50% of the small particles are accumulated in volume conversion.

In the composite catalyst according to the embodiment, the content of the catalyst composite particles is about 0.1 weight percent (wt %) to about 10 wt %, about 0.5 wt % to about 8 wt %, and about 1 wt % to about 6 wt %, or about 0.1 wt % to about 5 wt % and the content of the support is about 90 wt % to about 99.9 wt %, about 92 wt % to about 99.5 wt %, about 94 wt % to about 99 wt %, or about 95 wt % to about 99.9 wt %, based on the total weight of the composite catalyst. When the content of the catalyst composite particle and the content of the support are within the above ranges, ability of removing harmful gases such as nitrogen oxides discharged from internal combustion engines can be improved.

The content of the catalyst composite particles may be about 0.1 wt % to about 4 wt %, about 0.1 wt % to about 3 wt %, about 0.1 wt % to about 2 wt %, or about 0.1 wt % to about 1 wt %, with respect to the total weight of the composite catalyst. With the catalyst composite particles in a content in the above ranges, the composite catalyst may exhibit further improved performance in removing volatile organic compounds. When the content of the catalyst composite particles is excessively low, an expected effect may be insignificant. When the content of the catalyst composite particles is excessively high, an increase in catalytic effect due to an increased content may be insignificant.

An unpurified air stream may include a compound to be removed, which may be referred to herein as a contaminant compound, and the contaminant compound may include, for example, a volatile organic compound (VOC). The VOC is not particularly limited and may include any or all volatile organic compounds that are regarded as harmful to the human body or to the environment in industry locally or overseas. The VOC may include, for example, a polar compound, a nonpolar compound, or a combination thereof.

The VOC may be, for example, a nonpolar compound. The nonpolar compound may include, for example, an aliphatic hydrocarbon, an aromatic hydrocarbon, or a combination thereof. The aliphatic hydrocarbon and the aromatic hydrocarbon may be unsubstituted, or may be substituted with a substituent. The substituent may be, for example, an alkyl group, an alkenyl group, an alkynyl group, a cycloalkyl group, an aryl group, a heteroaryl group, an aralkyl group, a cycloalkenyl group, a heterocyclyl group, a halogen, or the like. The aliphatic hydrocarbon may include, for example, methane, ethane, propane, butane, pentane, hexane, or a combination thereof. The aromatic hydrocarbon may include, for example, benzene, toluene, xylene, or a combination thereof.

The VOC may be, for example, a polar compound. The polar compound may include, for example, ammonia (NH₃), an amine compound, an aldehyde compound, a ketone compound, an alcohol compound, a sulfur compound, a thiol compound, a halogenated hydrocarbon, a nitrogen oxide (NOₓ), a sulfur oxide (SOₓ), ozone, or a combination thereof. The amine compound may include, for example, methylamine, dimethylamine, trimethylamine, ethylamine, aniline, or a combination thereof. The aldehyde compound may include, for example, formaldehyde, acetaldehyde, propionaldehyde, butyraldehyde, or a combination thereof. The ketone compound may include, for example, dimethyl ketone, methyl ethyl ketone, diethyl ketone, methyl propyl ketone, dipropyl ketone, or a combination thereof. The alcohol compound may include, for example, methanol, ethanol, propanol, isopropanol, butanol, pentanol, hexanol, heptanol, or a combination thereof. The sulfur compound may include, for example, hydrogen sulfide, sulfur dioxide, elemental sulfur, sulfur oxide (SOₓ), or a combination thereof. The thiol compound may include, for example, methanethiol, ethanethiol, 1-propanethiol, 2-propanethiol, butanethiol, tert-butyl mercaptan, thiophenol, or a combination thereof.

The composite catalyst may further include a solid substrate. The composite catalyst may include, for example, a solid substrate, and a support disposed on the solid substrate. The solid substrate is not limited to any particular material, and may be formed of, for example, a polymer, a ceramic, a metal, or the like. The solid substrate is not limited to any particular form, and may be in the form of a mesh, a foam, a woven fabric, a non-woven fabric, a honeycomb structure, or the like. The support and the solid substrate may be disposed, for example, across an air stream and between upstream and downstream of the air stream. For example, the air stream may be disposed such that the air stream sequentially passes through one side of the support and the solid substrate and then the other side opposing the one side. The support may be disposed upstream of the air stream, relative to the solid substrate. That is, the support may be disposed such that the support comes into contact with the air stream before the solid substrate does. Alternatively, the support and the solid substrate may be disposed along the air stream, for example, from upstream of the air stream toward downstream of the air stream. For example, the air stream may be disposed such that the air stream moves along one side of the support and the solid substrate, and/or the other side opposing the one side. The support may have catalyst composite particles supported thereon. A composite catalyst including a solid substrate and a support disposed on the solid substrate may form, for example, a catalytic filter.

The composite catalyst according to an embodiment may be used in the treatment of odorous and harmful gases generated in a semiconductor manufacturing process, and is a catalyst capable of removing nitrogen oxides (NOx) in the general atmosphere.

In particular, this composite catalyst may be used to remove odorous harmful gases that are emitted without being treated in a regenerative thermal oxidizer (RTO).

The composite catalyst is, for example, a nitrogen oxide (NOx) removal catalyst.

The composite catalyst according to an embodiment may be used under conditions of an O₂ content of about 5 vol % to about 20 vol % (a residue of nitrogen) and a temperature of about 70° C. to 200° C., about 70° C. to 150° C., about 85° C. to 125° C., or about 85° C. to 100° C. A catalyst consisting of only palladium is not active under the above oxygen concentration. However, the composite catalyst according to an embodiment includes a group 6 element oxide in a content of about 0.1 parts by weight to about 5 parts by weight per 1 part by weight of a content of platinum, thereby exhibiting a synergistic effect between the platinum and the group 6 element oxide, so that the composite catalyst may exhibit high activity under an atmospheric oxygen concentration and at a low reaction temperature (for example, about 75° C. to about 200° C., 75° C. to about 150° C., or about 100° C. to about 125° C.). Here, activity may include an NO conversion rate, nitrogen selectivity, i.e., nitrogen gas selectivity, and an N₂O production amount.

The NO conversion rate of the composite catalyst may be used under the conditions of an O₂ content of about 5 vol % to about 20 vol % and a temperature of about 70° C. to about 200° C. The composite catalyst has an NO conversion rate of 45% or more or about 45% to about 70% and a N₂ selectivity of 51% or more or about 55% to about 80% under conditions of an O₂ content of about 10 vol % to about 20 vol %, a N₂ content of about 80 vol % to about 90 vol %, and a temperature of about 70° C. to about 200° C. The NO conversion rate may be evaluated under a condition of relative humidity of about 40% to about 60%, or 50%.

The condition of a temperature of about 70° C. to about 200° C. is, for example, a condition of a temperature of about 70° C. to about 150° C., about 70° C. to about 125° C., or about 100° C. to about 125° C.

An air purification device according to an embodiment includes a housing and the above-described composite catalyst, wherein the composite catalyst is disposed within the housing. The air purification device may purify unpurified air more easily by including the composite catalyst disposed within the housing. The shape of the housing is not particularly limited, and any shape capable of accommodating a composite catalyst is possible. The air purification device may include, for example, a housing and a catalytic t filter disposed within the housing. The catalyst filter may be a composite catalyst including a solid substrate and a support supporting catalyst composite particles disposed on the solid substrate. The shape of the housing is not particularly limited. The housing may include an inlet through which air flows in and an outlet through which air flows out, and a composite catalyst may be disposed between the inlet and the outlet.

According to another embodiment, there is provided a method of removing nitrogen oxides (NOx), the method including a process of contacting process gas with a composite catalyst for hydrogen-selective reduction: (H₂—SCR) to remove nitrogen oxides (NOx).

In the method of removing nitrogen oxides (NOx), the composite catalyst for H₂—SCR includes a support and catalyst composite particles supported on the support, wherein the catalyst composite particles include platinum and a group 6 element oxide, and the content of the group 6 element oxide is about 0.1 parts by weight to about 5 parts by weight with respect to 1 part by weight of the content of the platinum.

The process gas mainly may include semiconductor process gas, but also may include gases discharged during a display manufacturing process and combustion products from combustion engines. The contact method is not limited, but for example, a chamber process may be used to cause a gas flow from a gas inlet port to contact and react with the composite catalyst.

The group 6 element oxide may include an oxide containing tungsten (W), chromium (Cr), molybdenum (Mo), or a combination thereof. The mixing weight ratio of the platinum and the group 6 element oxide may be about 1:0.1 to about 1:2.

In the method of removing nitrogen oxides (NOx) according to an embodiment, the method may be performed under conditions of high activity and high reaction temperature, and the amount of N₂O generated may decrease at low temperatures and the activity window of the catalyst may be widened. As a result, improved removal ability for harmful gases such as nitrogen oxides can be provided.

In the method of removing nitrogen oxides (NOx), the composite catalyst has an NO conversion rate of 45% or more, or about 45% to about 70% and a N₂ selectivity of 51% or more, or about 55% to about 80% under conditions of an O₂ content of about 5 vol % to about 20 vol % and a temperature of about 70° C. to about 200° C.

The composite catalyst, for example, in the form of a catalytic filter, may be mounted on various indoor and outdoor air purification devices, such as air purifiers, air purification facilities, and air conditioning equipment, to remove volatile organic compounds or fine particles from unpurified air. The composite catalyst may also be applied to air purification devices and air purification systems to remove odorous substances, germs, pathogens, bacteria, and the like, as well as volatile organic compounds.

For example, a catalytic filter, which has a composite catalyst disposed on a solid substrate, may be provided.

The air purification device has an operation temperature of about 70° C. to about 125° C., about 85° C. to about 125° C., or about 100° C. to about 125° C., an oxygen (O₂) content of about 5 vol % to about 20 vol % or about 10 vol % to about 20 vol %, and a nitrogen (N₂) content of about 80 vol % to about 95 vol %.

In the air purification device, the injection amount of hydrogen (H₂) gas is about 100 ppm to about 20,000 ppm, about 100 ppm to about 15,000 ppm, about 100 ppm to about 10,000 ppm, about 100 ppm to about 8,000 ppm, or about 300 ppm to about 5,000 ppm, based on the total weight of exhaust gas and hydrogen gas.

In this specification, the ppm content of hydrogen gas refers to a weight of hydrogen gas per million of the total weight of exhaust gas and hydrogen gas.

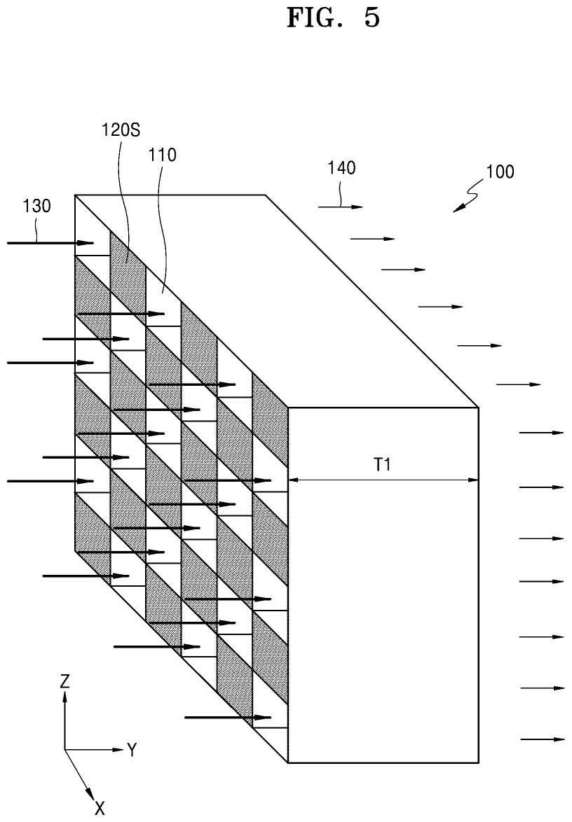

According to an example embodiment, a catalytic filter and an air purification system including the catalytic filter will be described in more detail with reference to FIGS. 5 to 9.

Referring to FIG. 5, a catalytic filter 100 includes an inflow side through which an air stream including a contaminant compound, e.g., an unpurified air 130 is introduced, and an outflow side through which purified air 140 is discharged. The unpurified air 130 may include one or more contaminant compounds.

The unpurified air 130 may include, for example, a particulate contaminant compound, a gaseous contaminant compound, or a combination thereof. The catalytic filter 100 may have a thickness T1 defined by a direction that extends from the inflow side to the outflow side (direction of Y-axis in FIG. 5).

The catalytic filter 100 may include a plurality of first recessed portions 110, each of which has an entrance portion located adjacent to the inflow side through which the unpurified air 130 is introduced, and has a bottom portion located adjacent to the outflow side through which the purified air 140 is discharged. The unpurified air 130 may be introduced into the catalytic filter 100 through the plurality of first recessed portions 110. The plurality of first recessed portions 110 may be arranged regularly and/or periodically. The plurality of first recessed portions 110 may be, for example, arranged in parallel to one another along the direction of the X-axis and/or the direction of the Z-axis in FIG. 5.

The catalytic filter 100 may include a plurality of first surfaces 120S exposed on the inflow side through which the unpurified air 130 is introduced. The plurality of first surfaces 120S may be arranged regularly and/or periodically. The plurality of first surfaces 120S may be, for example, disposed among the plurality of first recessed portions 110.

The plurality of first surfaces 120S may be, for example, spaced apart from one another while being disposed among the plurality of first recessed portions 110 that are spaced apart from one another in one direction along the inflow side, for example, in the direction of the X-axis and/or the direction of the Z-axis in FIG. 5. In one direction along the inflow side, for example, along the direction of the X-axis and/or the direction of the Z-axis in FIG. 5, the plurality of first surfaces 120S and the plurality of first recessed portions 110 may be arranged in an alternating fashion. One first recessed portion 110 may be surrounded by four first surfaces 120S, and one first surface 120S may be surrounded by four first recessed portions 110.

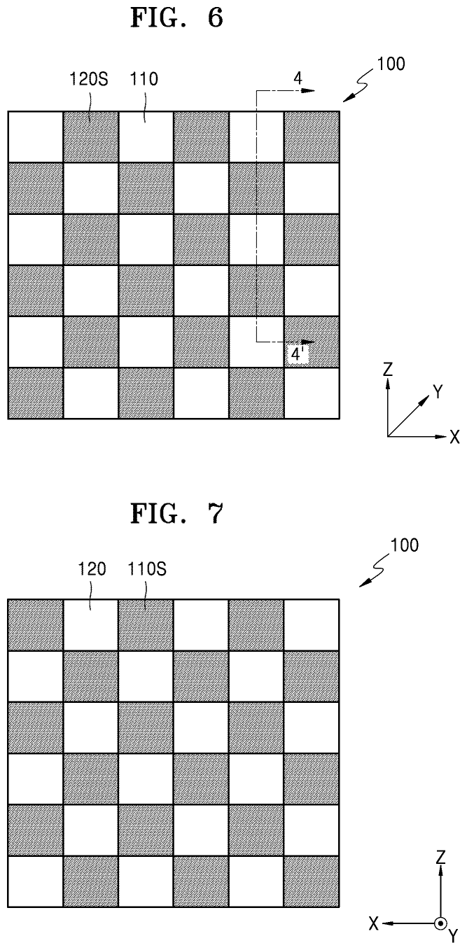

FIG. 6 is a front view of a front side, i.e., an inflow side, of the catalytic filter 100 in FIG. 5. FIG. 7 is a front view of a rear side, i.e., an outflow side, of the catalytic filter 100 in FIG. 5.

Referring to FIG. 6, the inflow side of the catalytic filter 100 may include a plurality of first recessed portions 110 and a plurality of first surfaces 120S.

Referring to FIG. 7, the outflow side of the catalytic filter 100 may include a plurality of second recessed portions 120 and a plurality of second surfaces 110S. The plurality of second recessed portions 120 may be outlets from which purified air is discharged. The purified air discharged through the second recessed portions 120 may be air obtained by removing the contaminant compounds from the unpurified air 130 introduced through the first recessed portions 110, or may be air containing harmless gases obtained by breaking down the contaminant compounds.

The plurality of second recessed portions 120 may be regularly and/or periodically arranged along the direction of the X-axis and/or the direction of the Z-axis in FIG. 7. The plurality of second surfaces 110S may be regularly arranged. The plurality of second surfaces 110S may be disposed between the plurality of second recessed portions 120.

The plurality of second surfaces 110S may correspond to the plurality of first recessed portions 110, and the plurality of second recessed portions 120 may correspond to the plurality of first surfaces 120S.

Referring to FIGS. 5 and 7, a second surface 110S may serve as the bottom portion of a first recessed portion 110, and a first surface 120S may correspond to the bottom portion of a second recessed portion 120.

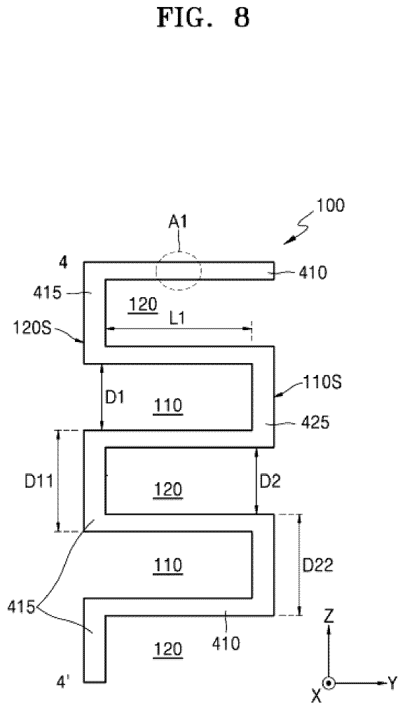

FIG. 8 is a cross-sectional view taken along line 4-4′ in FIG. 6.

The catalytic filter 100 may be a single-body structure, or a single-body frame. The catalytic filter 100 may have a frame that is entirely formed of one material, for example, a ceramic material, a polymer material, a metal material, or the like. The catalytic filter 100 may have, for example, a single-body structure or a monolithic structure, where the entire structure is connected as a single unit. Alternatively, the catalytic filter 100 may be a multilayer structure or a multilayer frame. Although not illustrated in the drawings, the catalytic filter 100 may have, for example, a multilayer structure including a solid substrate and an organic/inorganic composite catalyst disposed on the solid substrate. Referring to FIG. 8, the catalytic filter 100 may be a structure having a frame in which a plurality of first recessed portions 110 and second recessed portions 120 are sequentially arranged along the direction of the Z-axis. The catalytic filter 100 may include a plurality of horizontal areas 410 and a plurality of vertical areas 415, 425. The plurality of horizontal areas 410 may be spaced apart from one another along the direction of the Z-axis. The direction of the Z-axis corresponds to a vertical direction. The plurality of horizontal areas 410 may be arranged parallel to one another along the direction of the Y-axis. The plurality of horizontal areas 410 may have the same length or different lengths from each other. The plurality of horizontal areas 410 may be disposed between the plurality of vertical areas 415, 425. The plurality of horizontal areas 410 may be physically connected to one another through the plurality of vertical areas 415, 425. The plurality of vertical areas 415, 425 may be arranged parallel to one another, and spaced apart from one another. The plurality of vertical areas 415, 425 may be spaced apart from one another along the direction of the Z-axis. The direction of the Z-axis corresponds to a vertical direction. The plurality of vertical areas 415, 425 may be arranged parallel to one another along the direction of the Y-axis. The plurality of vertical areas 415, 425 may have the same length or different lengths from each other. The plurality of vertical areas 415, 425 may be disposed between the plurality of horizontal areas 410. The plurality of vertical areas 415, 425 may be physically connected to one another through the plurality of horizontal areas 410. The plurality of vertical areas 415, 425 may include a plurality of first vertical areas 415 and a plurality of second vertical areas 425. The plurality of first vertical areas 415 and the plurality of second vertical areas 425 may be spaced apart from one another along the direction of the Y-axis. The plurality of first vertical areas 415 may be spaced apart from one another along the direction of the Z-axis. The plurality of second vertical areas 425 may also be spaced apart from one another along the direction of the Z-axis. The plurality of first vertical areas 415 may be disposed on the inflow side to which the unpurified air 130 is supplied. The plurality of second vertical areas 425 may be disposed on the outflow side from which the purified air 140 is discharged.

The plurality of horizontal areas 410 may correspond to walls of the first recessed portion 110 and second recessed portion 120. The plurality of horizontal areas 410 may be located between the first recessed portion 110 and the second recessed portion 120, thereby serving as boundaries of each of the first and second recessed portions 110, 120. The walls may correspond to sidewalls of the first recessed portion 110 and the second recessed portion 120. The plurality of horizontal areas 410 may have the same thickness or different thicknesses from each other. The plurality of horizontal areas 410 may have the same thickness or a different thickness from a thickness of the plurality of vertical areas 415, 425. The horizontal areas 410 that serve as the walls of the first recessed portion 110 may be spaced apart from each other by a first distance D1 along the direction of the Z-axis. The horizontal areas 410 that serve as the walls of the second recessed portion 120 may be spaced apart from each other by a second distance D2 along the direction of the Z-axis. The first distance D1 and the second distance D2 may be the same or different from each other. The opening of the first recessed portion 110 and the opening of the second recessed portion 120 may have the same diameter and/or surface area or have different diameters and/or surface areas from each other. A Y-axis length L1 of each of the plurality of horizontal areas 410 may be the same or different from each other. The depth of a first recessed portion 110 and a second recessed portion 120 may be defined by the Y-axis length L1 of a horizontal area 410. The first recessed portion 110 and the second recessed portion 120 may have the same depth or different depths from each other. The plurality of first vertical areas 415 may form the bottom portions of the second recessed portions 120. The plurality of second vertical areas 425 may form the bottom portions of the first recessed portions 110. The bottom portions of the first recessed portions 110 and the bottom portions of the second recessed portions 120 may have the same air permeability or different air permeability from each other. A diameter D11 of a first vertical area 415 and a diameter D22 of a second vertical area 425 may be the same or different from each other. The first vertical area 415 and the second vertical area 425 may have the same thickness or different thickness from each other along the direction of the Y-axis.

The plurality of horizontal areas 410 and the plurality of vertical areas 415, 425 may be formed of the same material and may have a single-body or monolithic structure where the entire structure is connected as a single unit.

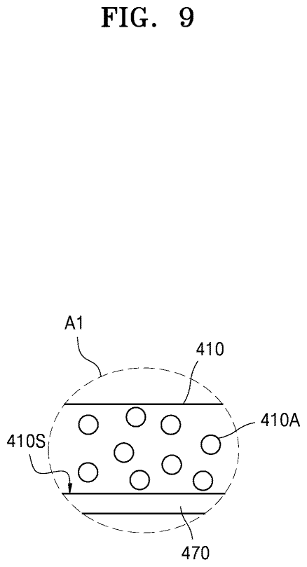

FIG. 9 is an enlarged view of a first area A1 of a horizontal area 410 in FIG. 8.

Referring to FIG. 9, the horizontal area 410 may include pores 410A. The vertical areas 415, 425 may include pores or may not include pores.

The horizontal area 410 and the vertical areas 415, 425 may include pores, and a pore density of the vertical areas 415, 425 may be higher or lower than a pore density of the horizontal area 410.

For example, the first vertical area 415 may include pores, and the second vertical area 425 may not include pores. Alternatively, the first vertical area 415 may not include pores, and the second vertical area 425 may include pores.

The first vertical area 415 and the second vertical area 425 may include pores, and a pore density of the second vertical area 425 may be higher or lower than a pore density of the first vertical area 415.

A catalyst layer 470 including a composite catalyst may be disposed on one surface 410S of the horizontal area 410. The catalyst layer 470 may be disposed, for example, in both the horizontal areas 410 and the vertical areas 415 and 425.

The composite catalyst is configured to remove a contaminant compound from an unpurified air stream containing the contaminant compound, and includes a support and catalyst composite particles supported on the support, wherein the catalyst composite particles include platinum and a group 6 element oxide, and a content of the group 6 element oxide is about 0.1 parts by weight to about 5 parts by weight with respect to 1 part by weight of a content of the platinum.

A method of preparing a composite catalyst for H₂—SCR according to an embodiment is as follows.

The method of preparing a composite catalyst for H₂—SCR according to an embodiment includes the processes of: introducing a platinum-containing salt and a group 6 element oxide as catalyst composite particle precursors on a support to prepare a support having supported catalyst composite particle precursors; and mixing a reducing agent with the support having the supported catalyst composite particle precursors to obtain a mixture, performing first heat treatment for the mixture to obtain catalyst precursors and then performing second heat treatment for the catalyst precursors.

Each process of the above-described method of preparing a composite catalyst will be described in more detail.

First, a support is prepared.

Subsequently, a platinum-containing salt and a group 6 element oxide as catalyst composite particle precursors are introduced on the support to prepare a support having supported catalyst composite particle precursors.

The process of preparing the support having supported catalyst composite particle precursors may be performed by mixing a support, catalyst composite particle precursors, and deionized water to obtain a mixture and heat-treating and stirring this mixture at about 100° C. to about 150° C. Through this heat treatment, components contained in the mixture may be well dispersed. The heat treatment may be performed, for example, at about 110° C. to about 140° C. or about 120° C. to about 130° C.

The content of deionized water in the mixture is about 100 parts by weight to about 5,000 parts by weight, about 100 parts by weight to about 3,000 parts by weight, about 100 parts by weight to about 2,000 parts by weight, about 150 parts by weight to about 1,800 parts by weight, or about 500 parts by weight to about 1,500 parts by weight based on 100 parts by weight of the support. When the content of deionized water is within the above range, the components contained in the mixture may be evenly dispersed.

The method of introducing a platinum-containing salt and a group 6 element oxide on a support may include, for example, dry impregnation, deposition precipitation, coprecipitation, wet impregnation, sputtering, gas-phase grafting, liquid-phase grafting, or the like.

The content of the catalyst composite particle precursors may be about 0.1 parts by weight to about 5 parts by weight, about 0.1 parts by weight to about 3 parts by weight, or about 0.1 parts by weight to about 1 part by weight with respect to 100 parts by weight of the support. When the content of the catalyst composite particle precursors is within the above range, a composite catalyst having excellent harmful gas removal performance may be prepared.

Next, a reducing agent is mixed with the support having the supported catalyst composite particle precursors to obtain a mixture, and first heat treatment is performed for the mixture to obtain catalyst precursors.

The temperature of the first heat treatment may be maintained at the same temperature as the reaction mixture in the process of preparing the support having the supported catalyst composite particle precursor. The first heat treatment may be performed at, for example, about 110° C. to about 140° C. or about 120° C. to about 130° C. The first heat treatment may be performed for about 5 hours to about 24 hours or about 10 hours to about 12 hours. During the first heat treatment, deionized water, a solvent, is removed, so a dried product may be obtained.

The reducing agent is, for example, hydrazine, sodium borohydride, or a combination thereof. The content of the reducing agent is about 0.1 parts by weight to about 50 parts by weight, about 1 part by weight to about 30 parts by weight, or about 2 parts by weight to about 20 parts by weight based on 100 parts by weight of the support. When the content of the reducing agent is within the above range, the platinum-containing salt which is catalyst composite particle precursors, may be well reduced into platinum.

Any platinum-containing salt may be used as the platinum-containing salt, and examples thereof include platinum-containing halides, platinum-containing nitrates, platinum-containing carbonates, platinum-containing phosphates, platinum-containing sulfates, or a combination thereof. For example, H₂PtCl₆ is used as the platinum-containing salt.

The group 6 element oxide may be an oxide containing a group 6 element. The oxide containing a group 6 element may be WO₃, MoO₃, Cr₂O₃, or a combination thereof.

When a group 6 element oxide is used as a catalyst composite particle precursor in the preparation of a composite catalyst according to an embodiment, a composite catalyst, free of an group 6 element in its elemental form, may be obtained in the finally obtained composite catalysts. For example, a composite catalyst containing Pt—WO₃ as the catalyst composite particles contains Pt and WO₃, but does not contain W, i.e., tungsten metal or tungsten in its elemental form. In this way, the tungsten (W)-free composite catalyst has greatly improved harmful gas removal ability.

The average particle dimeter (D50) of WO₃ is 25 μm or less, about 5 μm to about 25 μm, or about 10 μm to about 25 μm. When using WO₃ having such an average particle diameter, a surface area is widened, thereby making it easy to adsorb substances and improving the reactivity on the surface of the substance.

After the first heat treatment, a solvent may be removed, and a dried product may be obtained.

The dried product may be subjected to a second heat treatment after performing a grinding process. Here, the grinding process may be omitted. When performing the grinding process, agglomerations may be removed from the dried product, and when a second heat treatment is performed after this grinding process, a composite catalyst having excellent stability may be prepared.

The second heat treatment may be performed at a temperature of, for example, about 300° C. to about 900° C., about 300° C. to about 850° C., about 350° C. to about 800° C., about 400° C. to about 700° C., or about 400° C. to about 500° C. When the second heat treatment temperature is within the above range, a composite catalyst having excellent activity may be prepared while ensuring stability without deterioration of the components of the composite catalyst.

The second heat treatment may be performed, for example, in an oxidizing atmosphere or an inert atmosphere, for about 1 hour to about 24 hours, about 1 hour to about 12 hours, about 1 hour to about 10 hours, or about 2 hours to about 6 hours. The inert atmosphere may include, for example, a nitrogen atmosphere, an argon atmosphere, or a combination thereof. The oxidizing atmosphere may include, for example, an oxygen atmosphere, an air atmosphere, or the like. The stability of the composite catalyst can be secured by performing the second heat treatment.

When preparing a composite catalyst, a support in which mesopores are formed may be used as the support. The support may have micropores and mesopores.

A support having mesopores formed therein, for example, aluminosilicate having mesopores formed therein may be prepared by the following method.

The support is a support having mesopores, and
the support having mesopores is prepared by processes of: providing a bare support; contacting the bare support with an alkaline solution to prepare an alkali-treated support; performing heat-treatment on the alkali-treated support to prepare a heat-treated porous support; contacting the heat-treated porous support with an ammonium salt-containing solution to prepare an ion exchange-treated support; and drying and then heat-treating the ion exchange-treated support.

Bare support such as aluminosilicate is, for example, zeolite. The type of zeolite used is not limited. Examples of zeolites include, but are not limited to, beta zeolite, ZSM-5, FAU, MFI, BEA, and MOR, and any zeolite used in the relevant technical field may be used.

The alkaline solution may be an aqueous alkaline solution. The concentration of the alkaline solution may be, for example, 0.01 mole (M) or more, about 0.01 M to about 0.5 M, or about 0.05 M to about 0.3 M. The alkaline solution may include, for example, an alkaline compound. The alkaline compound may be, but is not limited to, NaOH, KOH, RbOH, CsOH, or the like, and any alkaline compound used in the relevant technical field may be used. The temperature of the alkaline solution may be, for example, about 20° C. to about 100° C., about 20° C. to about 50° C., or about 20° C. to about 40° C.

In the process of contacting the bare support with an alkaline solution to prepare an alkali-treated support, the time for which the bare support such as aluminosilicate is contacted with the alkaline solution may be, for example, about 1 minute to about 24 hours, about 5 minutes to about 12 hours, about 10 minutes to about 6 hours, about 10 minutes to about 2 hours, or about 10 minutes to about 1 hour. A porous support such as aluminosilicate having an increased pore size may be prepared by contacting the bare support such as aluminosilicate with the alkaline solution.

In the process of preparing an ion exchange-treated support, examples of the ammonium salt may include, but are not limited to, ammonium nitrate, ammonium sulfate, and ammonium chloride, and any ammonium salt used in the relevant technical field may be used. The concentration of the ammonium salt-containing solution may be, for example, about 0.1 M to about 5 M, about 0.1 M to about 3 M, or about 0.5 M to about 2 M. The temperature of the ammonium salt-containing solution may be, for example, about 50° C. to about 100° C., about 70° C. to about 100° C., or about 70° C. to about 90° C. The time for contacting the heat-treated porous support such as aluminosilicate with the ammonium salt solution may be, for example, about 30 minutes to about 24 hours, about 30 minutes to about 12 hours, about 30 minutes to about 6 hours, or about 30 minutes to about 2 hours.

In the process of drying and then heat-treating the ion exchange-treated support, the drying is performed at a temperature of about 100° C. to about 120° C. The drying time varies depending on the drying temperature, but, for example, the drying is carried out for about 10 hours to about 24 hours.

The heat treatment is performed, for example, at about 65° C. to about 90° C. and for about 0.5 hours to about 1.5 hours. The heat treatment is performed at about 450° C. to about 650° C. and for about 2 hours to about 10 hours, in an inert gas atmosphere.

According to an embodiment, the support having mesopores are produced by the processes of: introducing a support into a NaOH aqueous solution of about 0.5 to about 1.5 M, stirring the solution at about 65° C. to about 90° C. for about 0.5 to about 1.5 hours to obtain an alkali-treated product, separating the alkali-treated product, washing the separated product with distilled water several times, and drying the washed product to obtain an alkali-treated support; and introducing the alkali-treated support into an ammonium nitrate (NH₄NO₃) aqueous solution of about 0.5 M to about 1.5 M, stirring the solution at about 65° C. to about 90° C. for about 0.5 hours to about 1.5 hours to perform ion exchange, washing the ion-exchanged product, and then drying the washed product at about 100° C. to about 120° C. overnight to obtain a dry product. Then, this dry product may be calcined at about 450° C. to about 600° C., for example, 550° C., for about 2 hours to about 10 hours in an inert atmosphere to obtain a support having mesopores.

In the present specification, a substituent group may be introduced as at least one hydrogen in an unsubstituted mother group is replaced with another atom or functional group. Unless otherwise indicated, when a functional group is considered to be “substituted”, it means that the functional group is substituted with at least one substituent group including a C₁-C₄₀ alkyl group, a C₂-C₄₀ alkenyl group, a C₂-C₄₀ alkynyl group, a C₃-C₄₀ cycloalkyl group, a C₃-C₄₀ cycloalkenyl group, a C₆-C₄ or or C₇-C₄₀ aryl group, or a combination thereof. When a functional group is described as being “optionally substituted”, this means that the functional group may or may not be substituted with any one of the aforementioned substituent groups.

As used herein, a and b in “Cₐ-C_{b}” represent the number of carbon atoms in a specific functional group. That is, the functional group may include a to b number of carbon atoms. For example, “C₁-C₄ alkyl group” refers to an alkyl group having 1 to 4 carbon atoms, such as CH₃—, CH₃CH₂—, CH₃CH₂CH₂—, (CH₃)₂CH—, CH₃CH₂CH₂CH₂—, CH₃CH₂CH(CH₃)—, and (CH₃)₃C—.

A particular radical may be called a mono-radical or a di-radical depending on the context. For example, when a substituent group needs two binding sites for binding with the rest of the molecule, the substituent may be understood as a di-radical. For example, a substituent group specified as an alkyl group that needs two binding sites may be a di-radical, such as —CH₂—, —CH₂CH₂—, and —CH₂CH(CH₃)CH₂—. The term “alkylene” as used herein clearly indicates that the radical is a di-radical.

The terms “alkyl group” and “alkylene group” as used herein refer to a branched or unbranched aliphatic hydrocarbon group. Examples of the alkyl group include, without being limited to a methyl group, an ethyl group, a propyl group, an isopropyl group, a butyl group, an isobutyl group, a tert-butyl group, a pentyl group, and a hexyl group, each of which may be optionally substituted or unsubstituted. In an embodiment, the alkyl group may have 1 to 6 carbon atoms. For example, the alkyl group having 1 to 6 carbon atoms may be methyl, ethyl, propyl, isopropyl, butyl, iso-butyl, sec-butyl, pentyl, 3-pentyl, hexyl, or the like.

The term “alkenyl group” as used herein refers to a hydrocarbon group having 2 to 40 carbon atoms with at least one carbon-carbon double bond. Examples of the alkenyl group include an ethenyl group, a 1-propenyl group, a 2-propenyl group, a 2-methyl-1-propenyl group, a 1-butenyl group, and a 2-butenyl group. In an embodiment, the alkenyl group may be substituted or unsubstituted. In an embodiment, the alkenyl group may have 2 to 20 carbon atoms.

The term “alkynyl group” as used herein refers to a C₂-C₄₀ hydrocarbon group including at least one carbon-carbon triple bond. Examples of the alkynyl group may include an ethynyl group, a 1-propynyl group, a 1-butynyl group, and a 2-butynyl group. In an embodiment, the alkynyl group may be substituted or unsubstituted. In an embodiment, the alkynyl group may have 2 to 20 carbon atoms.

As used herein, the term “cycloalkyl group” refers to a fully saturated carbocyclic ring or ring system. For example, the cycloalkyl group may refer to a cyclopropyl group, cyclobutyl group, cyclopentyl group, or cyclohexyl group.

The term “aromatic” as used herein refers to a ring or ring system with a conjugated n electron system, and may refer to a carbocyclic aromatic group (e.g., a phenyl group) and a heterocyclic aromatic group (e.g., pyridine). In this regard, an aromatic ring system as a whole may include a monocyclic ring or a fused polycyclic ring (i.e., a ring that shares adjacent atom pairs).

The term “aryl group” as used herein refers to an aromatic ring or ring system (i.e., a ring fused from at least two rings that shares two adjacent carbon atoms) having only carbon atoms in its backbone, or a plurality of aromatic rings that are linked by a single bond, —O—, —S—, —C(═O)—, —S(═O)₂—, —Si(Ra)(Rb)— (where Ra and Rb are each independently a C₁-C₁₀ alkyl group), a C₁-C₁₀ alkylene group unsubstituted or substituted with a halogen, or —C(═O)—NH—. The aryl group may be substituted or unsubstituted, and may contain, for example, a phenyl group, a biphenyl group, a naphthyl group, a phenanthrenyl group, a naphthacenyl group, etc.

The term “arylene group” as used herein refers to an aryl group that requires at least two linking sites. A tetravalent arylene group may be an aryl group that requires four linking sites, and a divalent arylene group may be an aryl group that requires two linking sites. For example, the divalent arylene group may be —C₆H₄—O—C₆H₄— or the like.

The term “heteroaryl group” as used herein refers to an aromatic ring system with one ring, a plurality of rings that are fused to each other, or an aromatic ring system having a plurality of rings that are linked by a single bond, —O—, —S—, —C(═O)—, —S(═O)₂—, —Si(Ra)(Rb)— (where Ra and Rb are each independently a C₁-C₁₀ alkyl group), a C₁₀-C₁₀ alkylene group unsubstituted or substituted with a halogen, or —C(═O)—NH—, in which at least one member of the aromatic ring system is a heteroatom, i.e., not carbon. In the fused ring system, at least one heteroatom may be present in only one ring. For example, the heteroatom may be oxygen, sulfur, or nitrogen, but is not limited thereto. Examples of the heteroaryl group include, but are not limited to, a furanyl group, a thienyl group, an imidazolyl group, a quinazolinyl group, a quinolinyl group, an isoquinolinyl group, a quinoxalinyl group, a pyridinyl group, a pyrrolyl group, an oxazolyl group, and an indolyl group.

The term “heteroarylene group” as used herein may refer to a heteroaryl group that requires at least two linking sites. A tetravalent heteroarylene group may be a heteroaryl group that requires four linking sites, and a divalent heteroarylene group may be a heteroaryl group that requires two linking sites.

The term “aralkyl group” or “arylalkyl group” as used herein refers to an aryl group linked to a substituent via an alkylene group, such as a C₇-C₁₄ aralkyl group. Examples of the aralkyl group may include, but are not limited to, a benzyl group, a 2-phenylethyl group, a 3-phenylpropyl group, and a naphthylalkyl group. In an embodiment, the alkylene group may be a lower alkylene group (i.e., a C₁-C₄ alkylene group).

The term “cycloalkenyl group” as used herein refers to a carbocyclic ring or ring system with at least one double bond without an aromatic ring. For example, the cycloalkenyl group is a cyclohexenyl group.

The term “heterocyclic group” as used herein refers to a non-aromatic ring or ring system including at least one heteroatom in its cyclic backbone.

The term “halogen” as used herein refers to a stable element belonging to Group 17 of the periodic table, for example, fluorine, chlorine, bromine, or iodine. For example, the halogen may be fluorine and/or chlorine.

Hereinafter, one or more embodiments will be described in greater detail with reference to the following examples. However, it will be understood that these examples are provided only to illustrate the present disclosure, and not intended to limit the scope of the one or more embodiments of the present specification.

### Preparation of Composite Catalyst

### Example 1: Composite Catalyst (Mixing Weight Ratio of Pt and WO₃=1:0.5 (2:1))

0.026 g of H₂PtCl₆·6H₂O and 0.005 g of WO₃ (average particle diameter: about 20 μm) were added to 1 g of anatase-type TiO₂, 10 g of deionized water was further added thereto to obtain a mixture, and this mixture was then sonicated for 30 minutes.

The sonicated mixture was stirred at 125° C. and 600 revolutions per minute (rpm), 200 μL of hydrazine was added thereto based on 1 gram (g) of TiO₂, and this mixture was stirred overnight at 125° C. until deionized water evaporated to obtain a catalyst precursor.

The catalyst precursor was ground using a mortar, was heated to 400° C. at a heating rate of 5° C./min, and was then annealed at that temperature for 2 hours to prepare a composite catalyst (Pt/TiO₂—WO₃ (0.5 wt %)). In the composite catalyst, the content of WO₃ is 0.5 wt %, the content of Pt is 1 wt %, and the content of TiO₂ is 98.5 wt %. In the composite catalyst prepared according to Example 1, the mixing weight ratio of Pt and WO₃ is 1:0.5 (2:1).

### Example 2: Composite Catalyst (Mixing Weight Ratio of Pt and WO₃=1:1)

A composite catalyst was prepared in the same manner as in Example 1, except that the contents of TiO₂, H₂PtCl₆·6H₂O, and WO₃ were changed so that the content of WO₃ in the composite catalyst was 1 wt %, the content of Pt was 1 wt %, and the content of TiO₂ was 98 wt %. In the composite catalyst prepared according to Example 2, the mixing weight ratio of Pt and WO₃ is 1:1.

### Example 3: Composite Catalyst (Mixing Weight Ratio of Pt and WO₃=1:2)

A composite catalyst was prepared in the same manner as in Example 1, except that the contents of TiO₂, H₂PtCl₆·6H₂O, and WO₃ were changed so that the content of WO₃ in the composite catalyst was 2 wt %, the content of Pt was 1 wt %, and the content of TiO₂ was 97 wt %. In the composite catalyst prepared according to Example 3, the mixing weight ratio of Pt and WO₃ is 1:2.

### Example 4: Composite Catalyst (Mixing Weight Ratio of Pt and WO₃=1:0.1)

A composite catalyst was prepared in the same manner as in Example 1, except that the contents of TiO₂, H₂PtCl₆·6H₂O, and WO₃ were changed so that the content of WO₃ in the composite catalyst was 0.1 wt %, the content of Pt was 1 wt %, and the content of TiO₂ was 98.9 wt %. In the composite catalyst prepared according to Example 4, the mixing weight ratio of Pt and WO₃ is 1:0.1.

### Example 5: Composite Catalyst (Mixing Weight Ratio of Pt and WO₃=1:5)

A composite catalyst was prepared in the same manner as in Example 1, except that the contents of TiO₂, H₂PtCl₆·6H₂O, and WO₃ were changed so that the content of WO₃ in the composite catalyst was 5 wt %, the content of Pt was 1 wt %, and the content of TiO₂ was 94 wt %. In the composite catalyst prepared according to Example 5, the mixing weight ratio of Pt and WO₃ is 1:5.

### Example 6: Composite Catalyst (Mixing Weight Ratio of Pt and Cr₂O₃=1:0.5 (2:1))

A composite catalyst was prepared in the same manner as in Example 1, except that Cr₂O₃ was used instead of WO₃.

### Example 7: Composite Catalyst (Mixing Weight Ratio of Pt and MoO₃=2:1)

A composite catalyst was prepared in the same manner as in Example 1, except that MoO₃ was used instead of WO₃.

### Comparative Example 1: Pt/TiO₂

A composite catalyst was prepared in the same manner as in Example 1, except that 0.026 g of H₂PtCl₆·6H₂O was added to 1 g of TiO₂ and 10 g of deionized water was added thereto to prepare a mixture when preparing the mixture.

### Comparative Example 2: Composite Catalyst (Mixing Weight Ratio of Pt and WO₃=1:6)

A composite catalyst was prepared in the same manner as in Example 1, except that a mixture was prepared so that the content of WO₃ in the composite catalyst was 6 wt %, the content of Pt was 1 wt %, and the content of TiO₂ was 93 wt %. In the composite catalyst prepared according to Comparative Example 2, the mixing weight ratio of Pt and WO₃ is 1:6.

### Manufacture of Filters and Air Purification Devices

### Manufacture Example 1

The composite catalysts prepared in Example 1 were each positioned on a porous support made of glass fiber, to thereby prepare a filter with a catalyst layer disposed on a porous solid substrate.

A tube having an inlet and an outlet was vertically arranged, and the filter was arranged between the inlet and the outlet, wherein while air is supplied through the inlet and discharged through the outlet, the filter was arranged such that the filter intersects the air stream moving from the inlet toward the outlet within the tube. The filter was installed in the tube such that an organic-inorganic composite catalyst was disposed upstream of the air stream relative to the porous support. The tube corresponds to a reaction chamber. The tube and the filter correspond to an air purification device.

### Manufacture Example 2

A filter and an air purification device were manufactured in the same manner as in Manufacture Example 1, except that the composite catalyst of Example 2 was used instead of the composite catalyst of Example 1 as a composite catalyst.

### Manufacture Example 3

A filter and an air purification device were manufactured in the same manner as in Manufacture Example 1, except that the composite catalyst of Example 3 was used instead of the composite catalyst of Example 1 as a composite catalyst.

### Manufacture Example 4

A filter and an air purification device were manufactured in the same manner as in Manufacture Example 1, except that the composite catalyst of Example 4 was used instead of the composite catalyst of Example 1 as a composite catalyst.

### Manufacture Example 5

A filter and an air purification device were manufactured in the same manner as in Manufacture Example 1, except that the composite catalyst of Example 5 was used instead of the composite catalyst of Example 1 as a composite catalyst.

### Manufacture Example 6

A filter and an air purification device were manufactured in the same manner as in Manufacture Example 1, except that the composite catalyst of Example 6 was used instead of the composite catalyst of Example 1 as a composite catalyst.

### Comparative Manufacture Example 1

A filter and an air purification device were manufactured in the same manner as in Manufacture Example 1, except that the composite catalyst of Comparative Example 1 was used instead of the composite catalyst of Example 1.

### Comparative Manufacture Example 2

A filter and an air purification device were manufactured in the same manner as in Manufacture Example 1, except that the composite catalyst of Comparative Example 2 was used instead of the composite catalyst of Example 1.

### Evaluation Example 1: SEM-EDS Analysis of Composite Catalyst

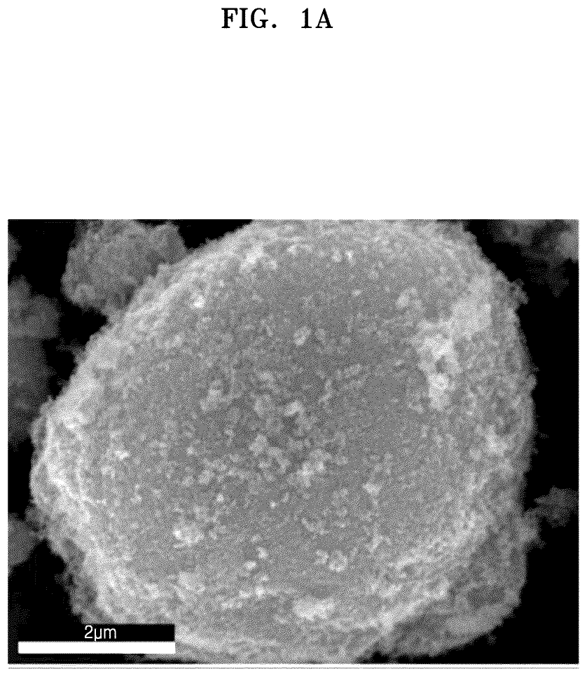

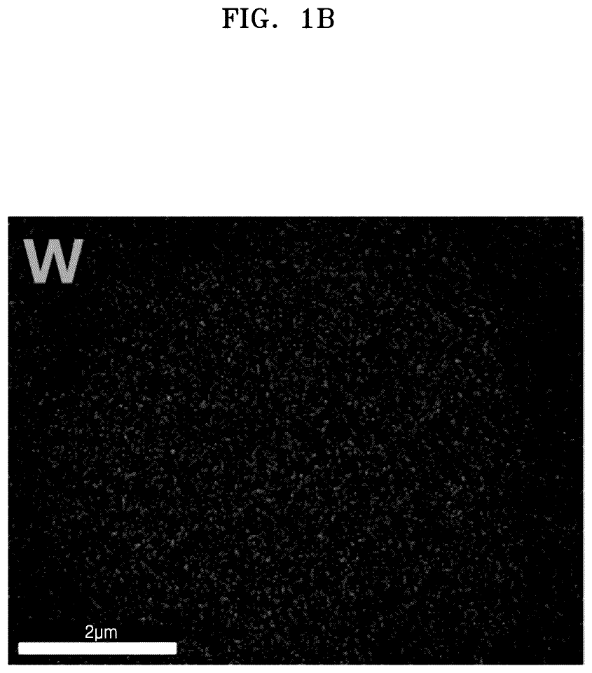

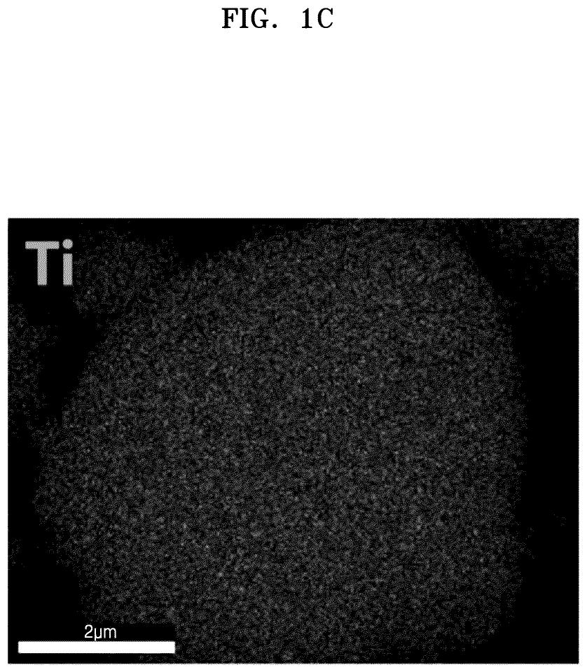

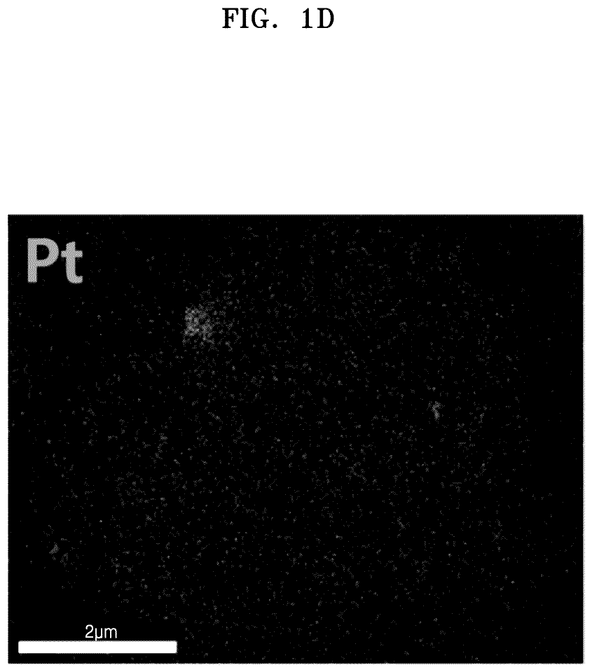

The composite catalyst prepared in Example 1 was analyzed using scanning electron microscopy (SEM)-energy dispersive spectroscopy (EDS). The results of SEM analysis are shown in FIG. 1A to 1D. FIGS. 1A to 1D show the SEM images of the composite catalyst prepared in Example 1.

As shown in FIGS. 1A to 1D, it could be found that platinum, tungsten, and titanium was present in the composite catalyst prepared in Example 1.

### Evaluation Example 2: Evaluation of NO Reduction Performance of Composite Catalyst (I)

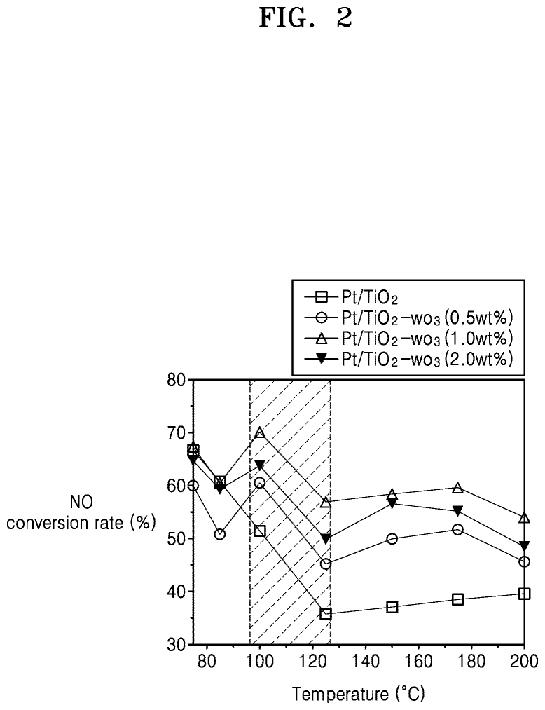

A NOx-containing gas as a contaminant compound was supplied to the inlet of each of the air purification devices of Manufacture Examples 1 to 6 and Comparative Manufacture Examples 1 and 2 manufactured using each of the composite catalysts obtained according to Examples 1 to 6 and Comparative Examples 1 and 2, and was passed through a filter including the catalyst layer and discharged, and then the NO conversion rate generated by the decomposition of NO at the outlet were measured according to temperature. The measurement results of the NO conversion rate are shown in FIG. 2. During the measurement, the content of NOₓ was 25 ppm, and the injection amount of H₂ gas was 4,000 ppm based on the total content of NOx-containing gas (exhaust gas) and hydrogen gas, and the operation temperature was in the range of 75° C. to 125° C., the oxygen content was 20 vol %, the nitrogen content was 80 vol %, and the relative humidity was 50%. In FIG. 2, Pt/TiO₂ represents Comparative Example 1, and Pt/TiO₂—WO₃ (0.5 wt %), Pt/TiO₂—WO₃ (1.0 wt %), and Pt/TiO₂—WO₃ (2.0 wt %) represent Examples 1, 2, and 3, respectively.

As shown in FIG. 2, the composite catalyst of Comparative Example 1 exhibited a high NO conversion rate at a temperature of lower than 100° C., but exhibited an average NO conversion rate of 37% at a high temperature of 125° C. or higher.

In contrast, the composite catalysts of Examples 1 to 3 exhibited greatly improved NO conversion rates compared to the composite catalyst of Comparative Example 1. In particular, it was found that the composite catalyst (Pt/TiO₂—WO₃) (WO₃ content: 1.0 wt %) of Example 2 exhibited the highest nitrogen conversion rate of 70% at a low temperature of 100° C., and exhibited the highest activity in a low-temperature range. In addition, it was found that the composite catalyst (Pt/TiO₂—WO₃) (1.0 wt %) of Example 2 exhibited an average NO conversion rate of 57% in a high-temperature range (higher than 125° C. and 200° C. or lower), and thus the activity window of the catalyst was widened.

In addition, the NO conversion rates of the air purification devices of Manufacture Examples 4 to 6 using the composite catalysts of Examples 4 to 6 and the air purification device of Comparative Manufacture Example 2 using the composite catalyst of Comparative Example 2 were evaluated in the same manner as the NO conversion rate evaluation method for the air purification device of Manufacture Example 1 using the composite catalyst of Example 1.

According to the results, the air purification devices of Manufacture Examples 4 to 6 using the composite catalysts of Examples 4 to 6 exhibited NO conversion rates equivalent to that of the air purification device of Manufacture Example 1 using the composite catalyst of Example 1. Thus, it was confirmed that nitrogen oxide removal efficiency was improved when the composite catalysts of Examples 4 to 6 were used.

In addition, the air purification device of Comparative Manufacture Example 2 using the composite catalyst of Comparative Example 2 exhibited an NO conversion rate equivalent to that of the air purification device of Comparative Manufacture Example 1 using the composite catalyst of Comparative Example 1.

### Evaluation Example 3: Evaluation of NO Reduction Performance of Composite Catalyst (II)

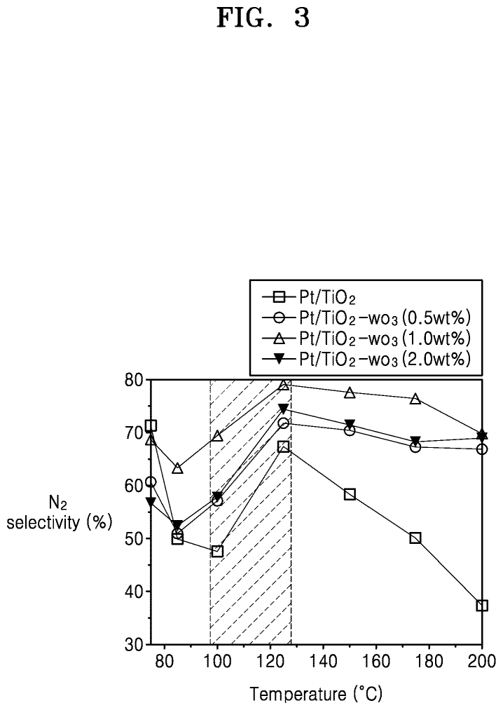

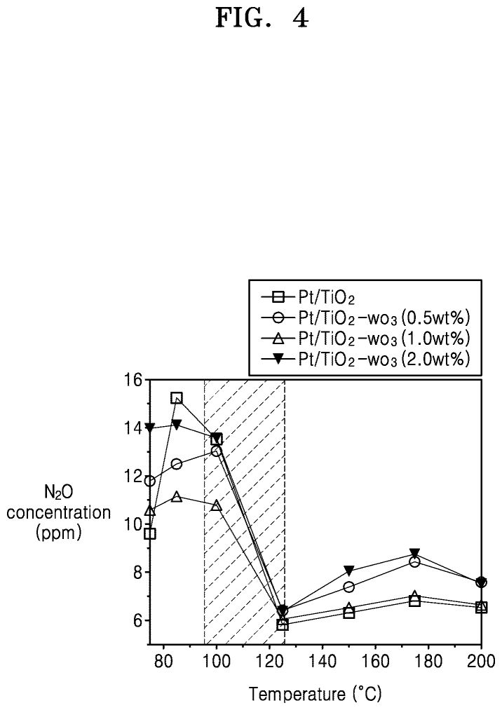

A NOx-containing gas as a contaminant compound was supplied to the inlet of each of the air purification devices of Manufacture Examples 1 to 3 and Comparative Manufacture Example 1 manufactured using each of the composite catalysts obtained according to Examples 1 to 3 and Comparative Example 1, and was passed through a filter including the catalyst layer and discharged, and then the nitrogen selectivity generated by decomposition of NO at the outlet and N₂O concentration were measured according to temperature. Some of the measurement results are shown in FIGS. 3 and 4, respectively. In the NOx-containing gas used during the measurement, the content of NOx was 25 ppm, the content of H₂ gas was 4,000 ppm, the content of oxygen gas was 20 volume %, the content of nitrogen gas was 80 volume %, the relative humidity was 50%, the temperature was 25° C., and the space velocity was 240,000 mVg·hr.

Referring to FIG. 3, it was found that, when the air purification device of Comparative Manufacture Example 1 using the composite catalyst (Pt/TiO₂) of Comparative Example 1 was used, nitrogen selectivity was 46% to 65% at a temperature of 100° C. to 125° C., but the nitrogen selectivity was decreased rapidly at a temperature of 125° C. or higher.

However, it was confirmed that, when the air purification devices of Manufacture Examples 1 to 3 using the composite catalyst of Examples 1 to 3 was used, improved nitrogen selectivity was maintained even in a high temperature range of 80° C. to 200° C., especially, higher than 125° C., unlike the air purification device of Comparative Manufacturing Example 1 using the composite catalyst of Comparative Example 1. In addition, very excellent nitrogen selectivity was exhibited at a temperature of 100° C. to 125° C.

In particular, as shown in FIG. 3, the air purification device of Manufacture Example 2 using the composite catalyst of Example 2 exhibited an excellent nitrogen selectivity of about 80% (at 125° C.). In addition, when the air purification devices of Manufacture Examples 1 and 3 using the composite catalysts of Examples 1 and 3 were used, excellent nitrogen selectivity of 55% to 74% was exhibited at a temperature of 100° C. to 125° C.

As described above, it was confirmed from the results of FIG. 3 that the composite catalysts of Examples 1 to 3 exhibited excellent nitrogen selectivity in both low-temperature and high-temperature ranges.

Referring to FIG. 4, the air purification devices of Manufacture Examples 1 to 3 using the composite catalyst of Examples 1 to 3 and the air purification device of Comparative Manufacture Example 1 using the catalyst of Comparative Example 1 showed a result of a reduction in the concentration of generated N₂O.

In particular, when the air purification device of Manufacture Example 2 using the complex catalyst of Example 2 was used, the amount of generated N₂O was significantly reduced in a low-temperature range (125° C. or lower), and the amount of generated N₂O was greatly reduced to 10.7 ppm at 100° C.

According to an aspect, a composite catalyst for H₂—SCR according to an embodiment has higher activity and lower reaction temperature than a catalyst containing only platinum, and an amount of N₂O generated can be reduced at low temperatures (for example, about 100° C. to about 125° C.), and an activity window of the catalyst can be widened. As a result, improved removal ability for harmful gases such as nitrogen oxides can be provided.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A composite catalyst for hydrogen-selective catalytic reduction configured to remove a contaminant compound from an air stream containing the contaminant compound, the composite catalyst comprising:
a support; and
catalyst composite particles supported on the support,
wherein the catalyst composite particles comprise platinum and a group 6 element oxide, and
a content of the group 6 element oxide is about 0.1 parts by weight to about 5 parts by weight with respect to 1 part by weight of a content of the platinum.

2. The composite catalyst of claim 1,
wherein the group 6 element oxide comprises an oxide containing tungsten, chromium, molybdenum, or a combination thereof.

3. The composite catalyst of claim 1,
wherein a mixing weight ratio of the platinum and the group 6 element oxide is about 1:0.1 to about 1:2.

4. The composite catalyst of claim 1,
wherein a content of the catalyst composite particles is about 0.1 weight percent to about 5 weight percent, based on a total weight of the composite catalyst.

5. The composite catalyst of claim 1,
wherein the support is silica, alumina, zeolite, titania, or a combination thereof.

6. The composite catalyst of claim 1,
wherein the catalyst composite particles comprise platinum and tungsten oxide.

7. The composite catalyst of claim 6,
wherein the composite catalyst is free of elemental tungsten.

8. The composite catalyst of claim 1,
wherein the composite catalyst is represented by Formula 1:
Ptₓ(WO₃)_{y} Formula 1
wherein, in Formula 1, 0.192≤x≤0.922, and x+y=1.

9. The composite catalyst of claim 1,
wherein the support further comprises mesopores, and
the mesopores have an average size of about 2 nanometers to about 50 nanometers.

10. The composite catalyst of claim 1,
wherein the composite catalyst is configured to remove the contaminant compound from the air stream containing the contaminant compound under conditions of an O₂ content of about 5 volume percent to about 20 volume percent and a temperature of about 70° C. to about 200° C.

11. The composite catalyst of claim 1,
wherein the composite catalyst has a nitrogen oxide conversion rate of 45% or more and an N₂ selectivity of 51% or more under conditions of an O₂ content of about 5 volume percent to about 20 volume percent and a temperature of about 70° C. to about 200° C.

12. The composite catalyst of claim 1,
wherein the composite catalyst further comprises boron trioxide, and
a content of boron trioxide is about 0.5 parts by weight to about 2 parts by weight based on 100 parts by weight of the support.

13. The composite catalyst of claim 1, wherein the composite catalyst is a catalyst for removing nitrogen oxides.

14. A method of removing nitrogen oxides, the method comprising: contacting an air stream including nitrogen oxides with a composite catalyst for hydrogen-selective catalytic reduction to remove nitrogen oxides,
wherein the composite catalyst comprises:
a support; and
catalyst composite particles supported on the support,
wherein the catalyst composite particles comprise platinum and a group 6 element oxide, and
a content of the group 6 element oxide is about 0.1 parts by weight to about 5 parts by weight with respect to 1 part by weight of a content of the platinum.

15. The method of claim 14,
wherein the group 6 element oxide comprises an oxide containing tungsten, chromium, molybdenum, or a combination thereof.

16. The method of claim 14,
wherein a mixing weight ratio of the platinum and the group 6 element oxide is about 1:0.1 to about 1:2.

17. The method of claim 14,
wherein the composite catalyst has an NO conversion rate of 45% or more and an N₂ selectivity of 51% or more under conditions of an O₂ content of about 5 volume percent to about 20 volume percent and a temperature of about 70° C. to about 200° C.

18. An air purification device comprising:
a housing; and
a composite catalyst for hydrogen-selective catalytic reduction,
wherein the composite catalyst is located within the housing, and
wherein the composite catalyst for hydrogen-selective catalytic reduction is configured to remove a contaminant compound from an unpurified air stream containing the contaminant compound, and comprises:
a support; and catalyst composite particles supported on the support,
wherein the catalyst composite particles comprise platinum and a group 6 element oxide, and
a content of the group 6 element oxide is about 0.1 parts by weight to about 5 parts by weight with respect to 1 part by weight of a content of the platinum.

19. The air purification device of claim 18,
wherein the air purification device is configured to operate at a temperature of about 70° C. to about 200° C.,
an oxygen content of about 5 volume percent to about 20 volume percent, an N₂ content of about 80 volume percent to about 95 volume percent, and a relative humidity of about 40% to about 60%.

20. The air purification device of claim 18,
wherein in the air purification device, an amount of hydrogen gas injected is about 100 parts per million to about 20,000 parts per million, based on a total weight of exhaust gas and hydrogen gas.
